(19) United States
(12) Patent Application Publication
(10) Pub. No.: US 2022/0192083 A1
(43) Pub. Date: Jun. 23, 2022

(54) NUTRIENT AMOUNT DETERMINATION DEVICE, NUTRIENT AMOUNT DETERMINATION METHOD, AND COMPUTER READABLE MEDIUM STORING NUTRIENT AMOUNT DETERMINATION PROGRAM

(71) Applicant: Rakuten Group, Inc., Tokyo (JP)

(72) Inventors: Masahiro KUWAHARA, Tokyo (JP); Takahiro IIZUKA, Tokyo (JP); Hirofumi KOKUBUN, Tokyo (JP); Shuichi SHINKAWA, Tokyo (JP)

(73) Assignee: Rakuten Group, Inc., Tokyo (JP)

(21) Appl. No.: 17/644,385

(22) Filed: Dec. 15, 2021

(30) Foreign Application Priority Data
Dec. 23, 2020 (JP) 2020-213386

(51) Int. Cl. A01C 21/00; A01G 7/06

(52) U.S. Cl. CPC A01C 21/007; A01C 21/005; A01G 7/06

(57) ABSTRACT

A nutrient amount determination device acquires number-of-users information indicating a number of users who use a sports facility within a predetermined period, the sports facility having lawn on which a sport is played. The nutrient amount determination device determines based on the acquired number-of-users information an application amount of at least one nutrient to be applied to the lawn of the sports facility by fertilization within the predetermined period.

### CROSS-REFERENCE TO RELATED PATENT APPLICATION

This application claims priority from Japanese Patent Application No. 2020-213386 filed on Dec. 23, 2020, the entire disclosure of which including the specification, claims, drawings, and abstract is incorporated herein by reference.

### BACKGROUND

### Technical Field

The present invention relates to a method for determining an amount of a nutrient to be applied to lawn in a sports facility as an element contained in fertilizer.

### Related Art

Among facilities in which sports are played, there are sports facilities that have lawns. Players perform a sport on that lawns. For example, a golf course has vast lawn. Thus, great effort and cost are required for managing the lawn. One element of the management of the lawn is fertilization. For example, fertilizer containing nutrients such as nitrogen, phosphorus, and potassium and fertilizer containing other nutrients are applied to the lawn. When the amounts of nutrients to be applied to the lawn is deficient, a growth state of it will deteriorate. On the other hand, when the amounts of nutrients to be applied to the lawn are excessive, it may have diseases. There may be a growth rate, durability, appearance, and the like of lawn suitable for a sport depending on a type of the sport played on the lawn, such as golf, soccer, and tennis. It is necessary to adjust the growth rate, durability, appearance, and the like of the lawn with an amount of the fertilizer. Furthermore, excessive fertilization results in an increase in lawn maintenance costs. Thus, in order to maintain the condition of the lawn favorably, it is necessary to determine an appropriate amounts of nutrients.

The amounts of nutrients to be applied to the lawn may be determined according to experience and intuition over many years by an experienced person. However, it is difficult to hand over such experience and intuition to others. Thus, it is desirable to quantitatively determine the amounts of nutrients. For example, JP 2002-107296A discloses that grass leaves cut from the lawn are washed, the lawn grass leaves are dried, and then inorganic elements contained in the lawn grass leaves are quantitatively analyzed by a near-infrared spectroscopic analyzer. JP 2002-107296 A further discloses that whether the analyzed amounts of inorganic elements are excessive or deficient is diagnosed in comparison with the amount of inorganic elements necessary for the lawn grass to grow soundly, and the excessive or deficient amount of inorganic elements is adjusted by fertilization.

### SUMMARY

Since the lawn grass in the sports facility is trodden by the players, stems and leaves of the lawn grass are broken or cells of the them are destroyed. Accordingly, the condition of the lawn also changes depending on a use situation of the sports facility. Although it is necessary to adjust the amount of the fertilizer according to the condition of the lawn, the determination of the condition of the lawn by visual observation or the like largely is dependent on experience, and is difficult to be said as a quantitative analysis.

The present invention has been made in view of the above points, and an example of an object of the present invention is to provide a nutrient amount determination device, a nutrient amount determination method, and a computer readable medium storing nutrient amount determination program which are capable of determining the amount of a nutrient to be applied to lawn according to a use situation of a sports facility having the lawn.

An aspect of the present invention is a nutrient amount determination device comprising: at least one memory having computer program code stored thereon; and at least one processor configured to read the computer program code from the at least one memory and operate as instructed by the computer program code, the computer program code comprising: acquisition code configured to cause at least one of the at least one processor to acquire number-of-users information indicating a number of users who use a sports facility within a predetermined period, the sports facility having lawn on which a sport is played; and determination code configured to cause at least one of the at least one processor to determine based on the acquired number-of-users information an application amount of at least one nutrient to be applied to the lawn of the sports facility by fertilization within the predetermined period.

Another aspect of the present invention is a nutrient amount determination method performed by at least one computer, the method comprising: acquiring number-of-users information indicating a number of users who use a sports facility within a predetermined period, the sports facility having lawn on which a sport is played; and determining based on the acquired number-of-users information an application amount of at least one nutrient to be applied to the lawn of the sports facility by fertilization within the predetermined period.

Yet another aspect of the present invention is a non-transitory computer readable medium storing thereon a nutrient amount determination program, the nutrient amount determination program, when executed by at least one processor, causing the at least one processor to: acquire number-of-users information indicating a number of users who use a sports facility within a predetermined period, the sports facility having lawn on which a sport is played; and determine based on the acquired number-of-users information an application amount of at least one nutrient to be applied to the lawn of the sports facility by fertilization within the predetermined period.

### BRIEF DESCRIPTION OF THE DRAWINGS

FIG. 1 is a diagram illustrating an example of an outline configuration of a golf course management system according to an embodiment;

FIG. 2 is a block diagram illustrating an example of an outline configuration of a center server according to the embodiment;

FIG. 3 is a diagram illustrating an example of information stored in databases;

FIG. 4 is a diagram illustrating an example of information stored in databases;

FIG. 5 is a diagram illustrating an example of functional blocks of a system controller in the center server according to the embodiment;

FIG. 6 is a diagram illustrating an example of a flow of information for determining an element application amount;

FIG. 7 is a diagram illustrating a display example of fertilization plan screen; and

FIG. 8 is a flowchart illustrating an example of element application amount determination processing by the system controller of the center server.

### DETAILED DESCRIPTION

Hereinafter, an embodiment of the present invention will be described in detail with reference to the drawings. The embodiment to be described below is an embodiment in a case where a sports facility of the present invention is a golf course. However, the sports facility is not limited to the golf course as long as the sports facility is a facility which has natural lawn and in which the sport is played on the lawn and the number of players who use the facility within a specific period can be identified. For example, when a user makes a use application or reservation of the sports facility, the number of users at this time can be grasped. Examples of a sports facility to which the present invention is applicable include a baseball park having lawn, a ground having lawn (on which soccer, rugby, American football, or other sports are played for example), and a lawn tennis court.

### [1. Configuration of Golf Course Management System]

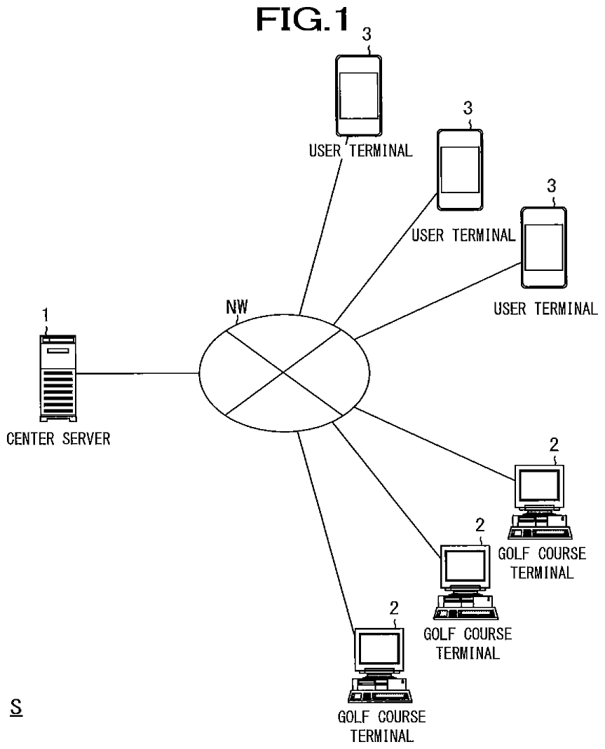

First, an outline of a configuration and a function of a golf course management system S according to the present embodiment will be described with reference to FIG. 1. FIG. 1 is a diagram illustrating an example of an outline configuration of the golf course management system S according to the present embodiment.

As illustrated in FIG. 1, the golf course management system S includes a center server 1, a plurality of golf course terminals 2, and a plurality of user terminals 3. The center server 1, each golf course terminal 2, and each user terminal 3 are connected to each other via a network NW. The network NW is constructed by, for example, the Internet, a dedicated communication line (for example, a community antenna television (CATV) line), a mobile communication network (including a base station and the like), a gateway, and the like.

The center server 1 is a server device that executes processing related to operations of golf courses registered in the golf course management system S. For example, the center server 1 may execute processing related to a golf course reservation site for reserving the golf courses. Users can reserve the use of a desired golf course by accessing the golf course reservation site. The center server 1 may transmit information such as a web page related to the golf course reservation site in response to requests from the user terminals 3.

The center server 1 performs processing related to a lawn management program for managing lawn at the golf courses. For example, all the golf courses registered in the golf course management system S may be automatically registered in the lawn management program, or only the golf courses that have applied for use may be registered in the lawn management program. The center server 1 may perform, for example, processing for supporting a fertilization plan. For example, the center server 1 predicts an amount of at least one of nutrients for grass of the lawn to be applied to the lawn by fertilization. This amount is referred to as an element application amount. In particular, the center server 1 determines the element application amount within a predetermined period based on the number of users (or the number of players) who use the golf course within the period. The nutrients for which the element application amount is predicted are referred to as target nutrients. The target nutrients may include at least essential elements among essential elements and useful elements, for example. In the present embodiment, the element application amounts are predicted for nitrogen, phosphorus, potassium, calcium, magnesium, sulfur, and manganese. However, a combination of the target nutrients is not limited to this combination. The number of target nutrients may be one or more.

The center server 1 may include a server device that executes processing related to the reservation of the golf course and a server device that executes processing for managing the lawn at the golf course. These server devices may be connected to each other via a network such as a local area network (LAN).

Each golf course terminal 2 is a terminal device used by an employee of the golf course. Examples of the golf course terminals 2 include a tablet computer, a personal computer, and the like. A web browser, an e-mail client, and the like may be installed in the golf course terminals 2. The golf course terminals 2 transmit a request to the center server 1 based on an operation by the employee, and displays information such as a web page transmitted from the center server 1 in response to the request. The employee confirms a reservation status of the golf course and performs fertilization management by using the golf course terminals 2. A terminal device for checking the reservation status and a terminal device for fertilization management may be separate devices.

Each user terminal 3 is a terminal device used by a user who uses the golf course reservation site. Examples of the user terminals 3 include a portable information terminal such as a smartphone or a tablet computer, a mobile phone, a personal digital assistant (PDA), a personal computer, a set-top box, and the like. Software such as a browser or an e-mail client may be installed in the user terminals 3. A dedicated application for using the golf course reservation site may be installed in the user terminals 3.

### [2. Configuration of Center Server]

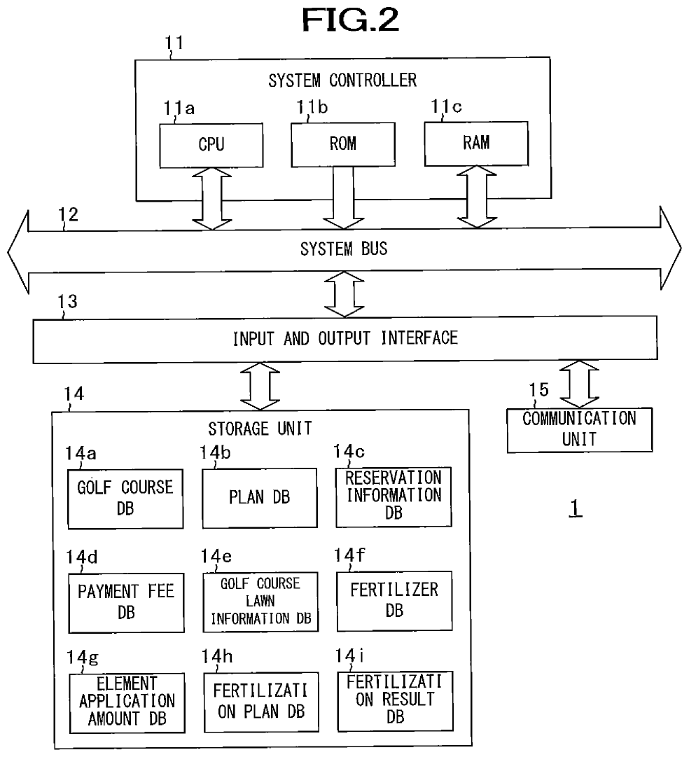

Next, a configuration of the center server 1 will be described with reference to FIGS. 2 to 4. FIG. 2 is a block diagram illustrating an example of an outline configuration of the center server 1 according to the present embodiment. As illustrated in FIG. 2, the center server 1 includes a system controller 11, a system bus 12, an input and output interface 13, a storage unit 14, and a communication unit 15. The system controller 11 and the input and output interface 13 are connected via the system bus 12.

The system controller 11 includes a central processing unit (CPU) 11a, a read only memory (ROM) lib, a random access memory (RAM) 11c, and the like.

The input and output interface 13 performs interface processing between the storage unit 14 and the communication unit 15, and the system controller 11.

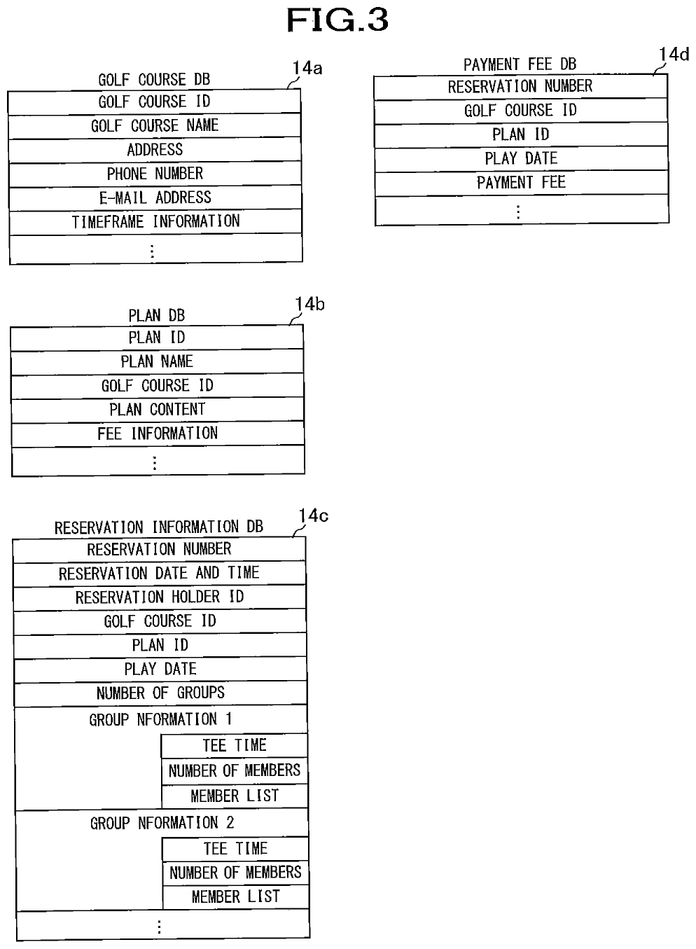

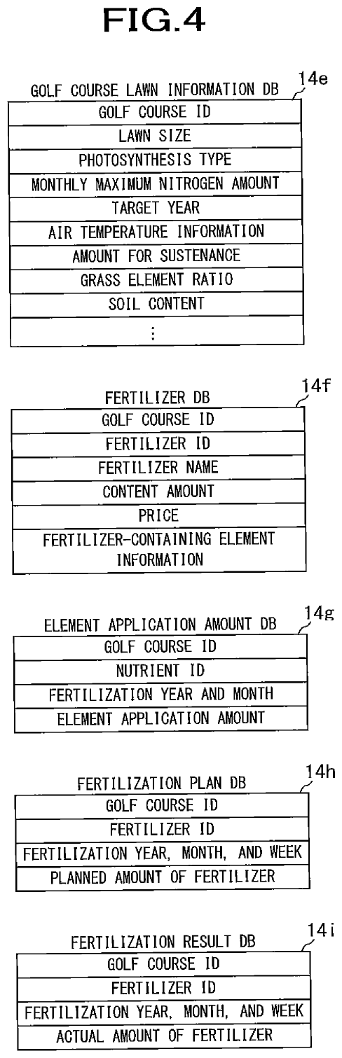

The storage unit 14 includes, for example, a hard disk drive or the like. The storage unit 14 stores databases such as a golf course DB 14a, a plan DB 14b, a reservation information DB 14c, a payment fee DB 14d, a golf course lawn information DB 14e, a fertilizer DB 14f, an element application amount DB 14g, a fertilization plan DB 14h, and a fertilization result DB 14i. “DB” is an abbreviation for a database. FIGS. 3 and 4 are diagrams illustrating examples of information stored in the databases.

As illustrated in FIG. 3, the golf course DB 14a stores golf course information regarding the golf courses that can be reserved by the golf course management system S for each golf course. Specifically, the golf course DB 14a stores, as the golf course information, a golf course ID, a golf course name, an address, a telephone number, an e-mail address, timeframe information, and the like in association with each other. The golf course ID is identification information for identifying the golf course. The timeframe information is information regarding timeframes assigned from a golf course of interest to the golf course management system S. At each golf course, a plurality of tee times of golf play in one day is determined in advance. For example, a time interval between tee times is predetermined and the plurality of tee times are determined based on the predetermined time interval (for example, 7 minutes). This time interval is referred to as a start interval. A period of time from a tee time to a next tee time is referred to as the timeframe. Each timeframe is identified with a combination of a golf course, a golf play date, and a tee time. Each golf course may delegate or allocate reception of reservations for all or some of timeframes provided from the golf course to the golf course management system S. Receptions of reservations for remaining timeframes may be performed by the golf course itself or may be allocated to another system. The timeframe information may indicate which timeframe is allocated to the golf course management system S. For example, the timeframe information may indicate the timeframe allocated to the golf course management system S in units of a predetermined period (for example, one day, one week, one month, one year, and the like). The timeframe information may include information indicating all timeframes provided from the golf course or information indicating the number of total timeframes.

In the plan DB 14b, plan information regarding a plan provided by the golf course is stored for each plan provided by each golf course. The plan corresponds to contents of a service that the user can receive when the golf course is reserved and used. Specifically, the plan DB 14b stores, as the plan information, a plan ID, a plan name, a golf course ID, plan contents, fee information, and the like in association with each other. The plan ID is identification information for identifying the plan. The golf course ID indicates the golf course that provides the plan of interest. The fee information indicates a fee per user for the plan of interest. In addition to a normal plan, a type of the plan may include a one-person reservation plan. The normal plan is a plan for which it is necessary to designate two or more as the number of players in a single group at the reservation. The one-person reservation plan is a plan that can be reserved such that one reserving person participates in a play at the timeframe designated by her/him. With respect to the one-person reservation plan, when reservations from a predetermined number of users or more are made for a timeframe of interest, the reservations are officially accepted. On the day of a play date, the reservation holders who made the reservations individually will play golf together, with each other. When the reservations from the predetermined number of users or more are not made by a predetermined number of days before the play date for the timeframe, the reservations may be automatically canceled.

In the reservation information DB 14c, reservation information regarding the reservation of the golf course is stored each time the reservation is made. Specifically, the reservation information DB 14c stores, as the reservation information, a reservation number, a reservation date and time, a reservation holder ID, a golf course ID, a plan ID, a play date, the number of groups, and one or more pieces of group information in association with each other. The reservation number is a number for identifying reservation. The reservation date and time is a date and time when the reservation was made. The reservation holder ID is identification information for identifying the user who made the reservation. The golf course ID indicates a reserved golf course. The plan ID indicates a reserved plan. The play date indicates a day on which golf is played. The number of groups indicates how many groups play golf. The number of groups corresponds to the number of reserved timeframes. A value of 1 or more is set as the number of groups. Each group information is information regarding a group that plays golf. Pieces of group information corresponding to the number of groups are stored in the reservation information DB 14c. Each group information includes a tee time, the number of members, and a member list. The tee time is a time at which a target group starts playing golf. The number of members is the number of members constituting a group. The number of members can be set by a reservation holder to two, three or four usually. However, the number of members that can be set may be limited depending on the golf course or the plan. The member list is a list of members constituting a group. The member list may include names of the members. The member list may include a user ID of a member who has a membership of the golf course reservation site. When reserving a golf course, a reserving user designates, for example, the golf course, the plan, the play date, the number of groups, the number of members of each group, and the like. The user terminal 3 transmits information designated by the reserving user to the center server 1. The center server 1 generates reservation information based on the received information, and stores the reservation information in the reservation information DB 14c. The tee time for each group may be designated by the reserving user. Alternatively, the reserving user may designate a period of time in which the play will be started, for example, in units of one hour. In this case, the center server 1 or the employee of the golf course may determine the tee time in the designated period. The reservation holder may designate members of each group. For example, the reserving user may input names of the members, or may select the members from among users registered on the golf course reservation site as golf friends of the reserving user. When the reservation is canceled, the center server 1 may delete the reservation information corresponding to the canceled reservation from the reservation information DB 14c.

In the payment fee DB 14d, payment fee information indicating a payment fee regarding a fee paid by the user who has reserved the golf course when the golf course is used is stored for each reservation for which the fee has been paid. Specifically, the payment fee DB 14d stores, as the payment fee information, a reservation number, a golf course ID, a plan ID, a play date, a payment fee, and the like in association with each other. The reservation number, the golf course ID, the plan ID, and the play date indicate the reservation, the golf course, the plan, and the play date for which the fee has been paid, respectively. When the user checks in (a procedure for starting the use of the golf course) or checks out (a procedure for ending the use of the golf course) at the golf course, the user pays a fee corresponding to the number of players. At this time, the employee of the golf course may designate the reservation and input the paid fee to the golf course terminal 2. The golf course terminal 2 transmits the input information to the center server 1. The center server 1 generates the payment fee information based on the received information, and stores the payment fee information in the payment fee DB 14d.

As illustrated in FIG. 4, the golf course lawn information DB 14e stores, as golf course lawn information, basic information regarding the lawn on the golf course for each golf course registered in the lawn management program. Each piece of information included in the golf course lawn information may be input by, for example, the employee of the golf course such as a greenkeeper. Specifically, the golf course lawn information DB 14e stores, as the golf course lawn information, a golf course ID, a lawn size, a photosynthesis type, a monthly maximum nitrogen amount, a target year, air temperature information, an amount for sustenance, a grass element ratio, a soil content, and the like in association with each other. The golf course ID indicates the target golf course. The lawn size is a total area size of the lawn at the golf course of interest. The photosynthesis type indicates a type of photosynthesis by the lawn at the golf course of interest. As the photosynthesis type, for example, either C3 photosynthesis or C4 photosynthesis may be selected. The monthly maximum nitrogen amount is an element application amount of nitrogen per unit area in a month on the lawn at the golf course of interest at an optimum air temperature for growth of the lawn grass. As an air temperature of the golf course approaches the optimum air temperature, photosynthesis by the lawn grass becomes more active, and growth performance of the lawn grass increases. As the element application amount of the nitrogen increases, a growth rate of the lawn grass increases. It is possible to appropriately grow the lawn grass by adjusting the element application amount of the nitrogen according to a level of the growth performance. Thus, it is assumed that an amount of nitrogen actually given in one month does not exceed the monthly maximum nitrogen amount at the maximum. The monthly maximum nitrogen amount may correspond to an amount of nitrogen, as a constituent of the lawn grass, lost from the lawn grass by mowing the lawn within one month. The monthly maximum nitrogen amount may be determined by the employee in consideration of, for example, an appearance and durability of the lawn ideal for the golf course of interest, climate of a region where the golf course is located, the frequency of mowing, a desired growth rate, and the like. Alternatively, the monthly maximum nitrogen amount may be common to all the golf courses. The target year indicates a year for which the element application amount is predicted. The air temperature information indicates an air temperature of the golf course in each month of the target year. The air temperature to be input may be, for example, an average air temperature. Alternatively, the air temperature to be input may be a highest air temperature or a lowest air temperature. The amount for sustenance may be stored in the golf course lawn information DB 14e for each target nutrient. The amount for sustenance refers to a weight of each target nutrient required in the soil to keep a condition of the lawn grass per unit area. It is assumed that nutrients absorbed by the lawn grass can be divided into nutrients that are used to grow the lawn grass and lost by mowing, and nutrients that are used to maintain the condition of the lawn rather than growth. The grass element ratio indicates how much each of a plurality of target nutrients, as elements constituting the lawn, is included in the lawn grass of the golf course of interest, relative to other target nutrients. For example, assuming that the amount of nitrogen included in the lawn grass is 1, the grass element ratio may indicate the amount of each of other elements. For example, an elemental composition ratio of the lawn grass may be specified by using a carbon, nitrogen, and sulfur (CNS) analysis, an inductivity coupled plasma (ICP) analysis, or the like, and the grass element ratio may be input based on the analysis result. The soil content may be stored in the golf course lawn information DB 14e for each target nutrient. The soil content is a weight of each nutrient included in the soil per unit area which the lawn grass covers in the golf course of interest. For example, the soil content may be detected by soil investigation.

The fertilizer DB 14f stores fertilizer information regarding a fertilizer that can be applied to the lawn for each fertilizer for each golf course. Specifically, the fertilizer DB 14f stores, as the fertilizer information, a golf course ID, a fertilizer ID, a fertilizer name, a content amount, a price, fertilizer-containing element information, and the like in association with each other. Each piece of information included in the fertilizer information may be input by, for example, the employee of the golf course. The golf course ID indicates the golf course of interest. The fertilizer ID is identification information for identifying a fertilizer at the golf course of interest. The content amount indicates a weight or a volume per fertilizer of interest. The fertilizer-containing element information indicates a ratio by which each target nutrient is included in the fertilizer with respect to the fertilizer of interest.

The element application amount DB 14g stores the element application amount predicted for a target nutrient for each combination of a golf course, a year, a month, and a target nutrient. Specifically, the element application amount DB 14g stores a golf course ID, a nutrient ID, fertilization year and month, and an element application amount in association with each other. The golf course ID indicates the golf course of interest. The nutrient ID is identification information for identifying the target nutrient. The fertilization year and month indicate a year and a month of interest.

The fertilization plan DB 14h stores the amount of the fertilizer planned by a golf course for each combination of the golf course, the fertilizer, the year, the month, and the week. Specifically, the fertilization plan DB 14h stores a golf course ID, a fertilizer ID, fertilization year, month, and week, and a planned amount of fertilizer in association with each other. The golf course ID indicates the golf course of interest. The fertilizer ID indicates the fertilizer of interest. The fertilization year, month, and week indicate the year, month, and week in which the fertilizer is planned to be applied. The planned amount of fertilizer indicates an amount of the fertilizer that has been planned. The planned amount of fertilizer is input with designating the fertilizer, the year, the month, and the week by the employee of the golf course.

The fertilization result DB 14i stores an amount of a fertilizer performed by the golf course for each combination of the golf course, the fertilizer, the year, the month, and the week. Specifically, the fertilization result DB 14i stores a golf course ID, a fertilizer ID, fertilization year, month, and week, and an actual amount of fertilizer in association with each other. The golf course ID indicates the golf course of interest. The fertilizer ID indicates the fertilizer of interest. The fertilization year, month, and week indicate the year, month, and week in which the fertilization was performed. The actual amount of fertilizer indicates an amount of the fertilizer applied. The actual amount of fertilizer is input with designating the fertilizer, the year, the month, and the week by the employee of the golf course.

The storage unit 14 stores various programs such as an operating system, a database management system (DBMS), and a server program. The server program is a program for causing the system controller 11 to execute processing related to the reservation of the golf course, processing for predicting the element application amount, and the like. For example, the server program may be acquired from another device via the network NW, or may be recorded on a recording medium such as a magnetic tape, an optical disk, or a memory card and may read via a drive device.

The communication unit 15 includes, for example, a network interface card or the like. The communication unit 15 is connected to the golf course terminal 2 and the user terminal 3 via the network NW, and controls a communication state with these devices.

### [3. Functional Outline of System Controller]

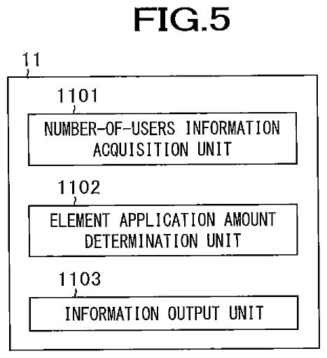

Next, a functional outline of the system controller 11 in the center server 1 will be described with reference to FIGS. 5 to 7. FIG. 5 is a diagram illustrating an example of functional blocks of the system controller 11 in the center server 1 according to the present embodiment. The system controller 11 functions as a number-of-users information acquisition unit 1101, an element application amount determination unit 1102, an information output unit 1103, and the like as illustrated in FIG. 5 by a CPU 11a reading and executing various program codes included in the server program.

### [3-1. Acquisition of Number of Users]

The number-of-users information acquisition unit 1101 acquires target-period number-of-users information indicating the number of users who use a target golf course within a predetermined target period. The target period may be designated by, for example, the employee of the golf course. Examples of a length of the target period include one month, three months, six months, and one year. In the present embodiment, the target-period number-of-users information regarding the number of users in one year is acquired. As described later, since the amount of a nutrient to be applied to the lawn during this target period is determined, this target period is usually a period in a future. Accordingly, the number-of-users information acquisition unit 1101 may predict the number of users within the target period.

For example, the number-of-users information acquisition unit 1101 may acquire past number-of-users information indicating the number of users who used the golf course within a past reference period before the target period. The number-of-users information acquisition unit 1101 may acquire target-period number-of-users information indicating the number of users predicted to use the target golf course in the target period based on the acquired past number-of-users information. For example, the number-of-users information acquisition unit 1101 may acquire the past number-of-users information based on the reservation information DB 14c. The number-of-users information acquisition unit 1101 may search for reservation information in which the play date is within the reference period from the reservation information DB 14c. The number-of-users information acquisition unit 1101 may acquire the past number-of-users information based on the found reservation information. For example, the number-of-users information acquisition unit 1101 may calculate the past number-of-users information by acquiring the number of members from each group information included in each reservation information and summing the acquired numbers of members. Alternatively, the number-of-users information acquisition unit 1101 may calculate the number of used timeframes by acquiring the number of groups included in each reservation information and summing the acquired numbers of groups. The number-of-users information acquisition unit 1101 may calculate the past number-of-users information by multiplying the total value by an average number of members per group. The average number of members per group may be calculated in advance by the number-of-users information acquisition unit 1101 and may be stored in the storage unit 14, for example. For example, the number-of-users information acquisition unit 1101 may acquire the number of members of each group from the reservation information in which the play date is in the past and may calculate an average value of the number of members. The number-of-users information acquisition unit 1101 may calculate the average number of members common to all the golf courses or may calculate the average number of members for each golf course. When there is a one-person reservation plan, the number-of-users information acquisition unit 1101 may calculate the number of users who have reserved for a timeframe as the number of members in the group who plays in the timeframe. When there is a limitation on the number of members per group depending on the plan (for example, two or more persons, three or more persons, or only four persons), the number-of-users information acquisition unit 1101 may calculate the average number of members per group for each limitation on the number of members. The number-of-users information acquisition unit 1101 may calculate the total value of the number of groups for each limitation on the number of members, and may multiply the total value by the average number of members corresponding to the limitation on the number of members.

The number of users that can be identified from the reservation information DB 14c is the number of users within a range of timeframes assigned to the golf course reservation site managed by the center server 1 among all the timeframes that can be provided by the target golf course. Thus, it is necessary to acquire the number of users corresponding to all the timeframes. For example, the number-of-users information acquisition unit 1101 may calculate, as an assignment ratio, a ratio of the timeframes assigned to the golf course reservation site among the timeframes provided by the golf course while referring to the timeframe information stored in the golf course DB 14a. The number-of-users information acquisition unit 1101 may calculate the number of users corresponding to all the timeframes by dividing the calculated number of users by the assignment ratio.

A length of the reference period may be the same as the length of the target period. The number-of-users information acquisition unit 1101 may acquire the number of users within the reference period acquired in consideration of the assignment ratio, as the target-period number-of-users information indicating the number of users within the target period. Here, a specific example will be described. It is assumed that the target period is one year of 2021, and today is Nov. 1, 2020. It is assumed that the reference period is from Nov. 1, 2019 to Oct. 31, 2020. The number of users of the target golf course in the golf course reservation site in the reference period was 10,000. When the assignment ratio is 0.4, an estimated value of the number of users in the reference period is 25,000. The number-of-users information acquisition unit 1101 may determine the estimated value as the number of users in the target period. The length of the reference period may be different from the length of the target period. In this case, the number-of-users information acquisition unit 1101 may adjust the number of users according to a ratio between the length of the reference period and the length of the target period. For example, when the length of the reference period is twice the length of the target period, the number-of-users information acquisition unit 1101 may calculate the number of users in the target period by dividing the estimated value of the number of users in the reference period by 2.

The number-of-users information acquisition unit 1101 may acquire the past number-of-users information based on the payment fee DB 14d. For example, the number-of-users information acquisition unit 1101 may search for the payment fee information in which the play date is within the reference period from the payment fee DB 14d. The number-of-users information acquisition unit 1101 acquires the plan ID and the payment fee from each payment fee information. The number-of-users information acquisition unit 1101 may determine the number of users of the golf course for each reservation for which the fee has been paid based on the payment fee and the fee information stored in the plan DB 14b in association with the acquired plan ID. The fee paid at the golf course is a fee corresponding to the number of members who used the golf course. The number of users for a target reservation can be identified by referring to the fee information. The number of members indicated by the reservation information may be different from the number of members who actually play golf on the golf course. On the other hand, the payment fee indicates the number of members who actually played golf on the golf course. Thus, a more accurate number of users can be acquired. The number-of-users information acquisition unit 1101 may calculate the past number-of-users information by summing the number of users for all the reservations in the reference period. The number-of-users information acquisition unit 1101 may calculate the target-period number-of-users information by dividing the assignment ratio from the past number-of-users information.

The number-of-users information acquisition unit 1101 may acquire the number of members who checked in at the golf course as the past number-of-users information. For example, each reservation holder who made the reservation of the golf course and each companion check in at the golf course. At this time, the employee of the golf course operates the golf course terminal 2 to identify the reservation corresponding to the user who checks in. For example, the employee may identify the reservation from the name of the user and the name of the reservation holder. Alternatively, in a case where an application for the golf course reservation site has been installed on the user terminal 3 carried by the user, the user may operate the application to display code information indicating the user ID of the user on the user terminal 3. The code information may be, for example, a one-dimensional bar code, may be a two-dimensional code, or may be a character string. The employee may inquire about the reservation corresponding to the user who checks in by optically reading the code information by a reading device connected to the golf course terminal 2 and transmitting the user ID obtained from the code information to the center server 1. When the reservation is identified, the employee performs an operation to complete the check in. In response to this operation, the center server 1 stores the reservation number, the play date, a check-in time, the user ID or the name of the user, and the like in the storage unit 14 in association with one another, for example. The number-of-users information acquisition unit 1101 may calculate the number of users who checked in within the reference period based on the information stored in the storage unit 14.

The number-of-users information acquisition unit 1101 may acquire reservation status information indicating a status of reservation for using the target golf course within the target period. The number-of-users information acquisition unit 1101 may acquire the target-period number-of-users information indicating the number of users predicted to use the golf course within the target period based on the acquired reservation status information. The reservation status information may be the reservation information DB 14c. For example, the number-of-users information acquisition unit 1101 acquires the reservation information in which the play date is within the target period from the reservation information DB 14c. The number-of-users information acquisition unit 1101 may calculate the number of timeframes reserved within the target period at a current point in time by acquiring the number of groups from each reservation information and summing the acquired numbers of groups. The number-of-users information acquisition unit 1101 may calculate the remaining number of days from today to the start date of the target period. The number-of-users information acquisition unit 1101 may predict the target-period number-of-users information based on the number of timeframes at the current point in time and the number of remaining days. The number of reserved timeframes among timeframes provided within a certain period is referred to as a reservation rate. When the reservation rate at a point in time of a specific day is calculated, the number-of-users information acquisition unit 1101 may acquire, from the reservation information DB 14c, reservation information in which the play date is within the target period and a reservation date and time is before the specific day. The number-of-users information acquisition unit 1101 may calculate the number of timeframes reserved at the point in time of the day based on the number of groups included in the acquired reservation information, and may divide the number of timeframes by the number of timeframes provided in the target period. As the period approaches the target period, the reservation rate of the timeframes of the period tends to become higher. The timeframes actually used by a group of reserved users playing golf among timeframes provided within a certain period is referred to as a consumption rate. The consumption rate corresponds to a final reservation rate when the period has elapsed. Thus, the number-of-users information acquisition unit 1101 may calculate a predicted value of the consumption rate by multiplying the number of timeframes at a current point in time by a coefficient corresponding to a current reservation rate and the number of remaining days. The coefficient may be, for example, a value of 1 or more. This coefficient may be larger as the number of remaining days increases, and may be smaller as the reservation rate at the current point in time is higher. For example, the number-of-users information acquisition unit 1101 may determine the coefficient based on a tendency of a combination of the number of days remaining until the target period and the reservation rate at this time and an actual consumption rate in the target period. Alternatively, the number-of-users information acquisition unit 1101 may generate a model for obtaining the consumption rate in the target period from the combination of the number of days remaining until the target period and the reservation rate at this time based on the reservation information DB 14c by a statistical method or machine learning. The number-of-users information acquisition unit 1101 may determine the consumption rate by using the generated model. The number-of-users information acquisition unit 1101 may calculate the number of timeframes to be used among the timeframes provided within the target period based on the consumption rate. The number-of-users information acquisition unit 1101 may calculate the target-period number-of-users information by multiplying the number of timeframes by the average number of members per group and the assignment ratio.

### [3-2. Determination of Element Application Amount]

The element application amount determination unit 1102 determines an amount of at least one nutrient to be applied by the fertilization to the lawn at the target golf course within the target period based on the number-of-users information acquired by the number-of-users information acquisition unit 1101. That is, the element application amount is determined. The grass of the lawn at the golf course is trodden by users during golf play. At this time, stems and leaves of the grass are broken, or cells of the grass are destroyed. As a result, the grass is worn off and the ground is exposed, or the grass withers. A height of the grass in the sports facility is adjusted short by mowing. For example, the height of the grass on the green is particularly short. Accordingly, the state of the lawn tends to change excessively depending on the frequency or the number of times the grass is trodden. It may be considered that the frequency or the like at which the grass is trodden is basically proportional to the number of users. Accordingly, when other conditions are the same, it is considered that there is a certain cause-and-effect relationship between the number of users within the target period and the state of the lawn at a point in time when the period has elapsed. Thus, it is reasonable to determine the element application amount based on the number of users of the golf course in the target period. Accordingly, excess or deficiency of the amount of fertilizer to be applied to the lawn can be suppressed by determining the element application amount based on the number of users.

The element application amount determination unit 1102 may increase the element application amount as the number of users indicated by the number-of-users information acquired by the number-of-users information acquisition unit 1101 is larger. As the number of users increases, the number of times the lawn grass is trodden within the target period increases. Accordingly, the state of the grass deteriorates as the number of users increases. It is necessary to increase the growth rate of the lawn in order to repair damaged parts of the lawn, or additional nutrients are required for the repair. The growth rate is adjusted by adjusting the element application amount.

The element application amount determination unit 1102 may determine an amount of a target nutrient to be used for the growth of the grass based on the number-of-users information. This amount may be, for example, a cut element amount. The cut element amount is an amount of the target nutrient as the constituent of the grass lost from the grass by mowing. Since the height of the lawn is kept at a constant height by mowing, the stems and leaves grown of the lawn grass are cut by mowing. The amount of portions cut by mowing increases as the growth rate of the lawn increases. The element application amount increases, and thus, the growth rate of the lawn grass can be increased. When the user of the golf course steps on the lawn and damages the lawn grass, it is necessary to encourage the growth of the grass in order for the grass to repair the damaged part. Accordingly, since the cut element amount is affected by the growth rate of the lawn grass, it is considered that it is reasonable to adjust the cut element amount according to the number of users.

The element application amount determination unit 1102 may determine the element application amount based on the determined cut element amount. For example, the element application amount determination unit 1102 may determine the cut element amount itself as the element application amount. Alternatively, the element application amount determination unit 1102 may determine the element application amount based on at least one of the amount for sustenance and the soil content, in addition to the cut element amount. In order to keep the lawn in a good condition, it is considered that both the nutrients to be used for the growth of the lawn grass (and these nutrients will be lost due to mowing) and the nutrients required to keep the condition of the lawn are required. It is considered that the cut element amount required for the growth of the lawn grass is affected by the growth rate of the lawn grass, while the amount for sustenance required for keeping the current condition is not affected by the growth rate. Thus, the amount for sustenance may not be adjusted by the number of users. It is considered that a nutrient with the same amount as an amount of the nutrient that has already included in the soil as the nutrient required for the lawn does not need to be applied by the fertilization.

The element application amount determination unit 1102 may determine an element application amount of each of the plurality of target nutrients. Here, the element application amount determination unit 1102 may determine a cut element amount of a predetermined first nutrient among the plurality of target nutrients based on the number-of-users information. The element application amount determination unit 1102 may determine a cut element amount of a second nutrient different from the first nutrient among the plurality of target nutrients based on the cut element amount of the first nutrient. The first nutrient may be, for example, nitrogen. Nitrogen is one of the three major nutrients for plants, and is highly important among the three major nutrients. The amount of nitrogen is generally the largest of the nutrients applied to the lawn. An element application amount of each nutrient can be appropriately determined, by determining an element application amount for nitrogen, which has a largest element application amount, and determining element application amounts of other nutrients having smaller element application amounts based on the element application amount of the nitrogen. For example, the element application amount determination unit 1102 may determine the cut element amount of the second nutrient based on the grass element ratio of the target golf course stored in the golf course lawn information DB 14e and the cut element amount of the first nutrient. For example, the element application amount determination unit 1102 may determine the cut element amount of the second nutrient by multiplying the cut element amount of the first nutrient by the ratio of the amount of the second nutrient contained in the grass to the amount of the first nutrient contained in the grass.

The element application amount determination unit 1102 may determine the reference amount of the target nutrient under the optimum air temperature for the growth of lawn in the target golf course based on the number-of-users information. The element application amount determination unit 1102 may determine the cut element amount of the target nutrient based on the determined reference amount and the air temperature within the target period. As described above, the element application amount determination unit 1102 may determine the reference amount for the first nutrient. The element application amount determination unit 1102 may determine a conditional maximum nitrogen amount as the reference amount. The conditional maximum nitrogen amount is a cut element amount of the nitrogen under a condition in which users corresponding to the number of users indicated by the number-of-users information use the target golf course within the target period. The conditional maximum nitrogen amount may be the nitrogen amount relative to the lawn per unit area. Here, the element application amount determination unit 1102 may determine the conditional maximum nitrogen amount in the target period. Alternatively, when there is a plurality of partial periods having the same length as each other within the target period, the element application amount determination unit 1102 may determine a conditional maximum nitrogen amount per partial period. The conditional maximum nitrogen amount per partial period is equal to the nitrogen amount obtained by dividing the conditional maximum nitrogen amount in the target period by the number of partial periods included in the target period. In the present embodiment, the length of the target period is one year, while the length of the partial period is one month. Thus, the element application amount determination unit 1102 may determine a conditional monthly maximum nitrogen amount as the reference amount. Here, the element application amount determination unit 1102 may determine the conditional monthly maximum nitrogen amount based on the monthly maximum nitrogen amount of the target golf course stored in the golf course lawn information DB 14e. For example, the element application amount determination unit 1102 may determine a maximum value of the number of users of the target golf course in one year. The maximum value of the number of users may be determined according to, for example, the total number of timeframes provided by the target golf course in one year. For example, when the number of users indicated by the number-of-users information is greater than or equal to the maximum value of the number of users, the element application amount determination unit 1102 may determine the conditional monthly maximum nitrogen amount that it the same as the monthly maximum nitrogen amount. When the number of users indicated by the number-of-users information is smaller than the maximum value of the number of users, the element application amount determination unit 1102 may decrease the conditional monthly maximum nitrogen amount as a difference between the number of users indicated by the number-of-users information and the maximum value is greater.

An example of determining a model for determining the conditional maximum nitrogen amount from the number-of-users information will be described. Here, a ratio of the number of users indicated by the number-of-users information to the maximum value of the number of users is defined as x. The maximum value of the number of users may be calculated, for example, by multiplying the total number of timeframes provided by the golf course by 4 or the average number of members. x satisfies 0≤x≤1. The conditional maximum nitrogen amount is defined as y. Here, the conditional maximum nitrogen amount y is decided by the following calculation expression.

y=a×x−b (here, when x≤c,y=a×c−b)

Here, all constants a, b, and c are real numbers. a satisfies a>0. c satisfies 0≤c<1. b satisfies b>0. a−b (that is, the conditional maximum nitrogen amount y in the case of x=1) it the same as the maximum nitrogen amount stored in the golf course lawn information DB 14e. a×c−b may be a minimum nitrogen amount under the optimum air temperature. The minimum nitrogen amount may be determined in advance by, for example, the employee of the golf course, or may be common to all the golf courses. For example, c may be a ratio of the assumed minimum number of users to the maximum value of the number of users. The minimum number of users may be determined in advance by the employee of the golf course, for example, based on the past number of users. A relatively low frequency or number of steps on the lawn may have aspects that contribute to the growth of the lawn and may not deteriorate the condition of the lawn. Thus, when x satisfies x≤c, the conditional maximum nitrogen amount may be constant. The constants a, b, and c are determined so as to satisfy these conditions. For example, the center server 1 may determine these constants according to the input conditions, or the employee may determine these constants. The golf course starts fertilization to the lawn of the golf course according to the element application amount provided from the center server 1 by using the determined constants. The employee of the golf course observes the condition of the lawn, for example, for each month, and determines the element application amount actually required based on the condition. The conditional maximum nitrogen amount considered to be reasonable at this time is calculated from the element application amount actually required. The above calculation expression may be optimized, for example, by changing the constants a, b, and c based on the number of users and the conditional maximum nitrogen amount considered to be reasonable. For example, a linear expression approximating a relationship between the number of users and the conditional maximum nitrogen amount may be determined by a least squares method. Alternatively, a curve expression approximating the relationship between the number of users and the conditional maximum nitrogen amount may be determined by curve fitting. For example, the center server 1 may perform optimization. The element application amount determination unit 1102 may calculate the conditional maximum nitrogen amount by using the optimized expression.

The element application amount determination unit 1102 determines the element application amount of the target nutrient based on the determined reference amount and the air temperature within the target period in a place where the target golf course is located. As described above, as the air temperature of the golf course is closer to the optimum air temperature, the growth performance of the lawn grass increases. It is necessary to increase the cut element amount as the growth performance increases. The conditional maximum nitrogen amount is the nitrogen amount under the optimum air temperature for the growth of the lawn grass. Thus, the element application amount determination unit 1102 may decrease the cut element amount as a difference between the optimum air temperature for the growth of the lawn and the air temperature within the target period is larger. For example, the element application amount determination unit 1102 may determine a coefficient within a range of 0 to 1 according to the difference between the air temperature optimum for the growth of lawn and the air temperature within the target period. The element application amount determination unit 1102 may decrease the coefficient as the air temperature difference is larger. The element application amount determination unit 1102 may determine the cut element amount by multiplying the reference amount by the coefficient. The optimum air temperature for the growth of the lawn may be set in advance. The optimum air temperature may be set in advance for each photosynthesis type of the lawn. The element application amount determination unit 1102 may determine the cut element amount of the target nutrient to be applied to the lawn of the target golf course in each partial period based on the air temperature in each of the plurality of partial periods included in the target period. The element application amount determination unit 1102 may determine the cut element amount by using the air temperature information stored in the golf course lawn information DB 14e.

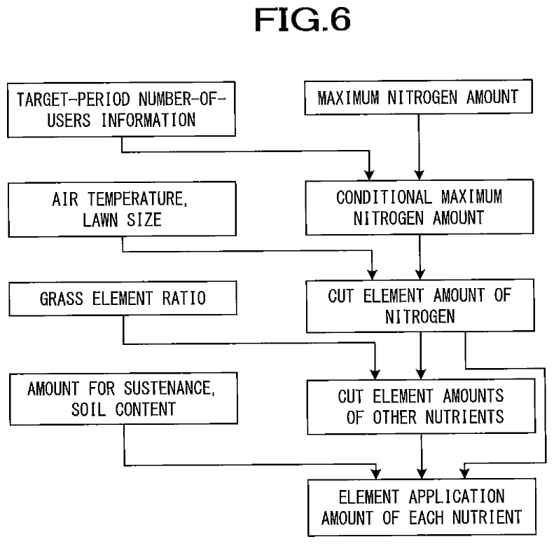

FIG. 6 is a diagram illustrating an example of a flow of information for determining the element application amount. As illustrated in FIG. 6, the element application amount determination unit 1102 may first determine the conditional maximum nitrogen amount based on the number-of-users information and the maximum nitrogen amount. Subsequently, the element application amount determination unit 1102 may determine the cut element amount of the nitrogen based on the conditional maximum nitrogen amount, the air temperature of the golf course, and the lawn size of the golf course. Subsequently, the element application amount determination unit 1102 may determine the cut element amount of each of the other target nutrients based on the cut element amount of the nitrogen and the grass element ratio. Subsequently, the element application amount determination unit 1102 may determine the element application amount for each target nutrient based on the cut element amount, the amount for sustenance, and the soil content.

When the element application amount is determined, the element application amount determination unit 1102 may store the determined element application amount in association with the golf course ID of the target golf course in the element application amount DB 14g.

### [3-3. Information Provision]

The information output unit 1103 outputs nutrient amount information indicating the amount of the target nutrient to be applied by the fertilization to the lawn in the target golf course based on the element application amount determined by the element application amount determination unit 1102. For example, the information output unit 1103 may transmit the nutrient amount information to the golf course terminal 2 of the target golf course. The nutrient amount information may be, for example, a character or a figure directly or indirectly indicating the element application amount.

When an amount of the fertilizer to be applied to the lawn within the target period is input by the employee of the target golf course, the information output unit 1103 may output the nutrient amount information indicating the excessive or deficient amount of the target nutrient based on the input amount of fertilizer, a content rate of the target nutrient in the fertilizer, and the element application amount determined by the element application amount determination unit 1102. For example, the information output unit 1103 acquires the content rate of the fertilizer designated by the employee from the fertilizer DB 14f. The information output unit 1103 calculates the target nutrient amount corresponding to the amount of fertilizer by multiplying the amount of fertilizer by the content rate. For example, the information output unit 1103 may calculate the excess or deficiency amount by subtracting the element application amount determined by the element application amount determination unit 1102 from the calculated target nutrient amount. The information output unit 1103 may generate the nutrient amount information indicating the calculated excessive or deficient amount. The nutrient amount information in this case may be, for example, a character or a figure directly or indirectly indicating the excessive or deficient amount.

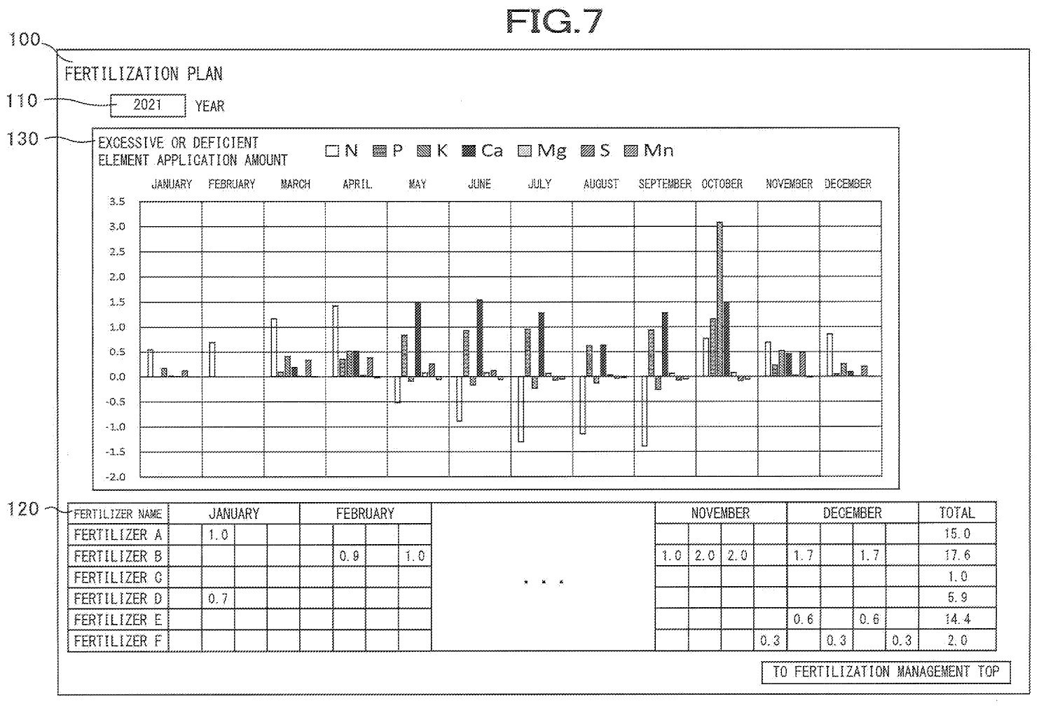

FIG. 7 is a diagram illustrating a display example of a fertilization plan screen. The fertilization plan screen is a screen for the employee of the golf course to input and view a fertilization plan. For example, the information output unit 1103 may generate a web page constituting the fertilization plan screen and may transmit the web page to the golf course terminal 2 in response to an operation of requesting the fertilization plan screen by the employee. As illustrated in FIG. 7, the fertilization plan screen 100 may include a period designation region 110, a fertilization plan table 120, a graph 130, and the like. The period designation region 110 is an input region for the employee to input a year of the fertilization plan to be viewed. The fertilization plan table 120 is a table including a cell for the employee to input the amount of fertilizer for each period for each fertilizer. For example, it is possible to input the amount of fertilizer in units of weeks. For example, when the year is input in the period designation region 110, the information output unit 1103 acquires the planned amount of fertilizer corresponding to the year from the fertilization plan DB 14h, and generates information such as an HTML document for displaying the fertilization plan table 120. The information output unit 1103 transmits the generated information to the golf course terminal 2, and the golf course terminal 2 updates the fertilization plan table 120 based on the received information. The graph 130 is a graph representing the excessive or deficient amount of each target nutrient for each month. For example, when the year is input in the period designation region 110, the information output unit 1103 acquires the element application amount determined so as to correspond to the year from the element application amount DB 14g, and acquires the planned amount of fertilizer corresponding to the year from the fertilization plan DB 14h. The information output unit 1103 calculates the excessive or deficient amount based on the acquired information, and generates the information such as the HTML document for displaying the graph 130. The information output unit 1103 transmits the generated information to the golf course terminal 2, and the golf course terminal 2 updates the graph 130 based on the received information. When the amount of fertilizer is input in any cell of the fertilization plan table 120, the golf course terminal 2 transmits, to the center server 1, the input amount of fertilizer in association with the fertilizer ID and the year, month, and week corresponding to the cell. The information output unit 1103 stores the amount of fertilizer received from the golf course terminal 2 in the element application amount DB 14g, and calculates the excessive or deficient amount again. The information output unit 1103 updates the graph 130.

A fertilization result screen may be provided in the golf course. The fertilization result screen is a screen for the employee of the golf course to input and view a result of the fertilization. The fertilization result screen may be similar to the fertilization plan screen except that the plan and the result are different.

### [4. Operation of Center Server]

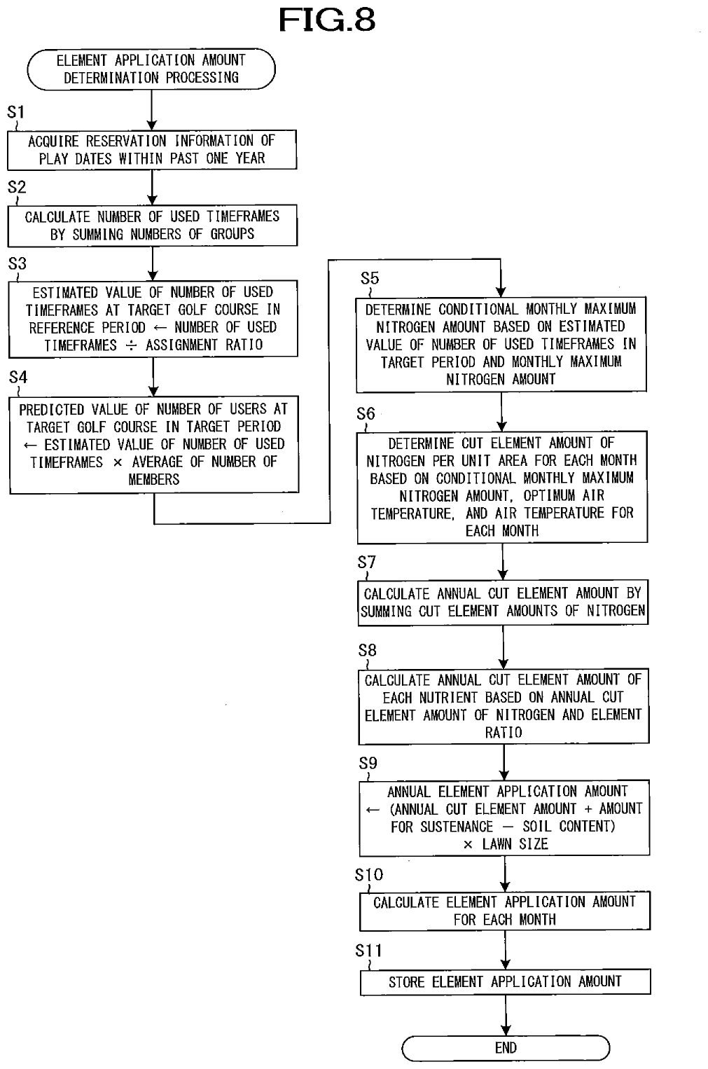

Next, an operation of the center server 1 will be described with reference to FIG. 8. FIG. 8 is a flowchart illustrating an example of element application amount determination processing by the system controller 11 of the center server 1. For example, the employee of the golf course inputs the golf course lawn information to the golf course terminal 2. For example, the employee inputs the lawn size, the photosynthesis type, the monthly maximum nitrogen amount, the target year, the air temperature information, the amount for sustenance, the grass element ratio, the soil content, and the like. The golf course terminal 2 transmits the input golf course lawn information to the center server 1. The system controller 11 stores the golf course lawn information in association with the golf course ID of the golf course in the golf course lawn information DB 14e. At this time, the center server 1 may execute the element application amount determination processing.

As illustrated in FIG. 8, the number-of-users information acquisition unit 1101 acquires, from the reservation information DB 14c, the reservation information in which the reservation date and time is within a period from one year ago to yesterday from among the pieces of reservation information of the target golf course (step S1). Subsequently, the number-of-users information acquisition unit 1101 acquires the number of groups from each acquired reservation information. The number-of-users information acquisition unit 1101 calculates the number of timeframes used through the golf course reservation site by summing the numbers of groups (step S2). Subsequently, the number-of-users information acquisition unit 1101 acquires the assignment ratio of the target golf course from the golf course DB 14a. The number-of-users information acquisition unit 1101 calculates an estimated value of the number of timeframes used in the target golf course in the reference period of the past one year by dividing the number of timeframes used through the golf course reservation site by the assignment ratio (step S3). Subsequently, the number-of-users information acquisition unit 1101 calculates a predicted value of the number of users in the target year in the target golf course by multiplying the estimated value of the number of timeframes by the average number of members per group (step S4).

Subsequently, the element application amount determination unit 1102 acquires the monthly maximum nitrogen amount from the golf course lawn information. The element application amount determination unit 1102 calculates the conditional monthly maximum nitrogen amount based on the monthly maximum nitrogen amount and the predicted value of the number of users in the target year (step S5). At this time, the element application amount determination unit 1102 may increase the conditional monthly maximum nitrogen amount as the number of users increases.

Subsequently, the element application amount determination unit 1102 acquires the photosynthesis type and the air temperature information from the golf course lawn information. The element application amount determination unit 1102 acquires the optimum air temperature corresponding to the photosynthesis type. The element application amount determination unit 1102 determines the cut element amount of the nitrogen for the lawn per unit area for each month based on the conditional monthly maximum nitrogen amount, the optimum air temperature, and the air temperature information (step S6). At this time, the element application amount determination unit 1102 may increase the cut element amount as a difference between the air temperature of each month and the optimum air temperature is smaller. Subsequently, the element application amount determination unit 1102 calculates an annual cut element amount per unit area by summing the cut element amounts per unit area (step S7).

Subsequently, the element application amount determination unit 1102 acquires the grass element ratio from the golf course lawn information. The element application amount determination unit 1102 calculates an annual cut element amount per unit area for each of phosphorus, potassium, calcium, magnesium, sulfur, and manganese based on an annual cut element amount of the nitrogen and the element ratio (step S8).

Subsequently, the element application amount determination unit 1102 acquires the amount for sustenance and the soil content from the golf course lawn information. For each target nutrient, the element application amount determination unit 1102 calculates a necessary amount by adding the amount for sustenance to the annual cut element amount, and calculates an annual element application amount per unit area by subtracting the soil content from the necessary amount. For each target nutrient, the element application amount determination unit 1102 calculates the annual element application amount by multiplying the annual element application amount per unit area by the lawn size (step S9). Subsequently, the element application amount determination unit 1102 calculates a ratio of the cut element amount of nitrogen in each month to the annual cut element amount of the nitrogen. For each target nutrient, the element application amount determination unit 1102 calculates an element application amount for each month by multiplying the annual element application amount by each calculated ratio (step S10). Subsequently, the element application amount determination unit 1102 stores the calculated element application amount in association with the golf course ID of the target golf course in the element application amount DB 14g (step S11), and the element application amount determination processing ends.

As described above, according to the present embodiment, the center server 1 acquires the target-period number-of-users information indicating the number of users who use the golf course within the target period. The center server 1 determines the element application amount of at least one nutrient to be applied to the lawn of the golf course within the target period based on the acquired target-period number-of-users information. In this case, the element application amount of at least one nutrient to be applied to the lawn of the sports facility within the target period is determined based on the number of users who use the golf course within the target period. Accordingly, the amount of the nutrient to be applied to the lawn can be determined according to the use situation of the golf course having the lawn.

Here, the center server 1 may increase the element application amount as the number of users indicated by the target-period number-of-users information is larger. In this case, it is possible to determine the element application amount of the nutrient corresponding to a change in the condition of the lawn due to a change in a degree to which the lawn is trodden according to the number of users.

The center server 1 may acquire the past number-of-users information indicating the number of users who have used the golf course within the past reference period before the target period. The center server 1 may acquire the target-period number-of-users information indicating the number of users predicted to use the golf course within the target period based on the acquired past number-of-users information. In this case, the number of users in the target period is predicted based on past results of the number of users. Accordingly, the number of users within the target period can be appropriately predicted.

The center server 1 may acquire the reservation status information indicating a status of reservation for using the golf course within the target period. The center server 1 may acquire the target-period number-of-users information indicating the number of users predicted to use the golf course within the target period based on the acquired reservation status information. In this case, the number of users in the target period is predicted based on the status of the reservation for using the golf course within the target period. Accordingly, the number of users within the target period can be appropriately predicted.

The center server 1 may determine the cut element amount of the nutrient to be used for the growth of the lawn based on the target-period number-of-users information, and may determine the element application amount based on the determined cut element amount. It is considered that it is necessary to promote the growth of the lawn by the fertilization in order for the lawn to repair the part damaged by being trodden. Since this damage varies depending on the number of users, the amount of the nutrient to be applied to the lawn can be appropriately determined.

Here, the center server 1 may determine the conditional maximum nitrogen amount based on the target-period number-of-users information. The center server 1 may determine the cut element amount based on the determined conditional maximum nitrogen amount and the air temperature within the target period. In this case, when the users indicated by the target-period number-of-users information use the golf course, the conditional maximum nitrogen amount under the air temperature optimum for the growth of the lawn is determined. The cut element amount to be used for the growth of the lawn is determined based on the conditional maximum nitrogen amount and the air temperature within the target period. The lawn has the highest growth performance under the optimum air temperature for the growth of the lawn, and thus, the amount of the nutrient required is the highest. Accordingly, the amount of the nutrient to be applied to the lawn can be appropriately determined by setting the conditional maximum nitrogen amount to the maximum value of the amount of the nutrient according to the growth of the lawn and setting the cut element amount to be smaller than the conditional maximum nitrogen amount according to the air temperature within the target period.

The center server 1 may determine the cut element amount for each of the plurality of partial periods based on the conditional maximum nitrogen amount and the air temperature in each of the plurality of partial periods included in the target period. The center server 1 may determine the element application amount for each of the plurality of partial periods based on the determined cut element amount. In this case, while the number of users in units of target periods is used, the amount of the nutrient to be applied to the lawn is determined in units of partial periods shorter than the target period.

Here, the center server 1 may determine the cut element amount of the first nutrient based on the target-period number-of-users information. The center server 1 may determine the cut element amount of the second nutrient based on the determined cut element amount and the grass element ratio. In this case, first, the cut element amount is determined based on the number of users for the first nutrient. For the second nutrient, the cut element amount is determined based on the amount of the first nutrient and the grass element ratio which is the ratio of the nutrient as the constituent element of the lawn. Accordingly, the appropriate amount of the nutrient can be determined according to the configuration of the lawn.

Here, the first nutrient may be nitrogen. In this case, a first amount of the nitrogen is determined based on the number of users. Nitrogen is considered as an important nutrient among the nutrients to be applied to the lawn, and the amount of the nitrogen to be applied to the lawn is large among the nutrients. A second amount can be appropriately determined by determining the second amount of the second nutrient different from the nitrogen based on the first amount of the nitrogen having a large element application amount.

The center server 1 may output the nutrient amount information indicating the amount of the nutrient to be applied to the lawn based on the determined element application amount. In this case, the amount of the nutrient to be applied to the lawn can be presented to a user of the lawn management program.

Here, when the amount of the fertilizer to be applied to the lawn within the target period is input, the center server 1 may output the nutrient amount information indicating the excessive or deficient amount of the nutrient based on the input amount of fertilizer, the content rate of the nutrient by the fertilizer, and the determined element application amount. In this case, it is possible to present how much amount of the nutrient to be applied to the lawn by the fertilization is deficient or excessive to the user of the lawn management program.

1. A nutrient amount determination device comprising:
at least one memory having computer program code stored thereon; and
at least one processor configured to read the computer program code from the at least one memory and operate as instructed by the computer program code, the computer program code comprising:
acquisition code configured to cause at least one of the at least one processor to acquire number-of-users information indicating a number of users who use a sports facility within a predetermined period, the sports facility having lawn on which a sport is played; and
determination code configured to cause at least one of the at least one processor to determine based on the acquired number-of-users information an application amount of at least one nutrient to be applied to the lawn of the sports facility by fertilization within the predetermined period.

2. The nutrient amount determination device according to claim 1, wherein the determination means is configured to increase the application amount as the number of users indicated by the acquired number-of-users information is larger.

3. The nutrient amount determination device according to claim 1, wherein the computer program code further comprises past number-of-users information acquisition code configured to cause at least one of the at least one processor to acquire past number-of-users information indicating a number of users who used the sports facility within a past period before the predetermined period, and
the acquisition code is configured to cause at least one of the at least one processor to acquire the number-of-users information indicating the number of users predicted to use the sports facility within the predetermined period based on the acquired past number-of-users information.

4. The nutrient amount determination device according to claim 1, wherein the computer program code further comprises reservation status information acquisition code configured to cause at least one of the at least one processor to acquire reservation status information indicating a status of reservation for using the sports facility within the predetermined period, and
the acquisition code is configured to cause at least one of the at least one processor to acquire the number-of-users information indicating the number of users predicted to use the sports facility within the predetermined period based on the acquired reservation status information.

5. The nutrient amount determination device according to claim 1, wherein the determination code is configured to cause at least one of the at least one processor to determine a growth use amount of the at least one nutrient to be used for growth of grass in the lawn based on the acquired number-of-users information, and determine the application amount based on the determined growth use amount.

6. The nutrient amount determination device according to claim 5, wherein the determination code is configured to cause at least one of the at least one processor to determine a reference amount of the at least one nutrient to be used for the growth of the grass in the lawn at an optimum air temperature for the growth of the grass based on the acquired number-of-users information, and determine the growth use amount based on the determined reference amount and an air temperature within the predetermined period.

7. The nutrient amount determination device according to claim 6, wherein the determination code is configured to cause at least one of the at least one processor to determine the growth use amount for each of a plurality of partial periods included in the predetermined period based on the determined reference amount and an air temperature in each of the plurality of partial periods, and determine the application amount for each of the plurality of partial periods based on the determined growth use amount.

8. The nutrient amount determination device according to claim 5, wherein
the at least one nutrient includes a first nutrient and a second nutrient different from the first nutrient, and
the determination code is configured to cause at least one of the at least one processor to determine the growth use amount of the first nutrient based on the acquired number-of-users information, and determine the growth use amount of the second nutrient based on the determined growth use amount of the first nutrient and ratio information indicating a ratio between an amount of the first nutrient and an amount of the second nutrient which are included in the grass in the lawn as constituents of the grass.

9. The nutrient amount determination device according to claim 8, wherein the first nutrient is nitrogen.

10. The nutrient amount determination device according to claim 1, wherein the computer program code further comprises output code configured to cause at least one of the at least one processor to output nutrient amount information indicating an amount of the at least one nutrient that should be applied to the lawn by fertilization based on the determined application amount.

11. The nutrient amount determination device according to claim 10, wherein the output code is configured to cause at least one of the at least one processor to, in a case where an amount of fertilizer to be applied to the lawn within the predetermined period is input, output the nutrient amount information indicating an excessive or deficient amount of the at least one nutrient based on the input amount of fertilizer, amass percentage of the at least one nutrient in the fertilizer, and the determined application amount.

12. A nutrient amount determination method performed by at least one computer, the method comprising:
acquiring number-of-users information indicating a number of users who use a sports facility within a predetermined period, the sports facility having lawn on which a sport is played; and
determining based on the acquired number-of-users information an application amount of at least one nutrient to be applied to the lawn of the sports facility by fertilization within the predetermined period.

13. A non-transitory computer readable medium storing thereon a nutrient amount determination program, the nutrient amount determination program, when executed by at least one processor, causing the at least one processor to:
acquire number-of-users information indicating a number of users who use a sports facility within a predetermined period, the sports facility having lawn on which a sport is played; and
determine based on the acquired number-of-users information an application amount of at least one nutrient to be applied to the lawn of the sports facility by fertilization within the predetermined period.
